(19) United States
(12) Patent Application Publication
(10) Pub. No.: US 2010/0032541 A1
(43) Pub. Date: Feb. 11, 2010

(54) TELESCOPIC SUPPORT DEVICE FOR STANDS

(76) Inventors: CHANG-HUI CHEN, Hsin She Hsiang (TW); Chi-Ching Liao, Taichung City (TW)

Correspondence Address: LEONG C LEI, PMB # 1008, 1867 YGNACIO VALLEY ROAD, WALNUT CREEK, CA, 94598, US

(21) Appl. No.: 12/187,387

(22) Filed: Aug. 7, 2008

(51) Int. Cl. F16M 13/00

(52) U.S. Cl. 248/527

(57) ABSTRACT

The telescopic support device contains a number of tubular segments cascaded together by a number of intermediate segments. Each tubular segment has an outward bulge formed along a top aperture. A flat and rigid spacer is positioned in the bulge. Each intermediate segment has a cylindrical body with a C-shaped cross section and a socket besides a top aperture of the body. A curved plastic piece is positioned between the socket and the body of the intermediate segment. When each intermediate segment has its body threaded into a tubular segment, and another tubular segment is threaded into the intermediate segment, a bolt could be screwed through the socket, the bulge, and then against the spacer. The spacer in turn pushes the plastic piece so as to lock the inner tubular segment.

### (A) TECHNICAL FIELD OF THE INVENTION

The present invention generally relates to instrument or equipment stands, and more particularly to a telescopic support device for instrument or equipment stands.

### (B) DESCRIPTION OF THE PRIOR ART

FIGS. 6 and 7 show a conventional stand for equipment or musical instrument which contains a telescopic support device raised vertically by a tripod. The support device contains a first tubular segment 20, a second tubular segment 23 threaded in a top aperture of the first tubular segment 20, and a third tubular segment 26 threaded in a top aperture of the second tubular segment 23. The top apertures of the first and second tubular segments 20 and 23 are wrapped in two tubular sleeves 21, respectively. The sleeves 21 are usually made of a zinc alloy and formed by casting. A plastic ring is positioned around an inner circumference of a top aperture of each sleeve 21. Each sleeve 21 also has a fastening bolt 22 running tangentially to the top aperture so as to tighten the plastic ring in gripping the tubular segment 23 or 26. To further prevent the tubular segments 23 and 26 from slipping, two C-shaped collars 24 are positioned along the tubular segments 23 and 26, respectively. The collars 24 are also usually made of a zinc alloy and formed by casting. Each collar 24 also has a fastening bolt 25 running tangentially through the C shape's gap in gripping the tubular segment 23 or 26 at an appropriate position. As such, if a sleeve 21 is not tight enough to hold an inner tubular segment, it could be prevented from slipping into an outer tubular segment by its collar 24.

The sleeves 21 and the collars 24 are costly items, adding significant cost to a stand especially when a large number of them are required. In addition, various sleeves 21 and collars 24 have to be prepared by a manufacturer so as to fit on tubular segments of different diameters. Furthermore, fastening by gripping is a difficult and not-so-reliable approach in securing the structure of a stand.

### SUMMARY OF THE INVENTION

The primary purpose of the present invention is to provide a novel telescopic support device so as to obviate the foregoing shortcomings.

The telescopic support device contains a number of tubular segments cascaded together by a number of intermediate segments. Each tubular segment has an outward bulge formed along a top aperture. A nut is positioned either in front of or behind the bulge. A flat and rigid spacer is positioned in the bulge.

Each intermediate segment has a cylindrical body with a C-shaped cross section and a socket besides a top aperture of the body. A curved plastic piece is positioned between the socket and the body of the intermediate segment. When each intermediate segment has its body threaded into a tubular segment, the spacer, the bulge, and the nut are housed inside the socket.

As such, when another tubular segment is threaded into the intermediate segment, a bolt could be screwed through the socket, the bulge, and then against the spacer. The spacer in turn pushes the plastic piece so as to lock the inner tubular segment.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a telescopic support device according to an embodiment of the present invention raised by a tripod.

FIG. 2 is a perspective diagram showing a fastening mechanism of the telescopic support device of FIG. 1.

FIG. 3 is a sectional diagram showing the fastening mechanism of FIG. 2.

FIG. 4 is a perspective diagram showing a fastening mechanism of a telescopic support device according to another embodiment of the present invention.

FIG. 5 is a sectional diagram showing the fastening mechanism of FIG. 4.

FIG. 6 is a perspective diagram showing the various components of a conventional telescopic support device.

FIG. 7 is a perspective diagram showing the conventional telescopic support device of FIG. 6 after its assembly.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

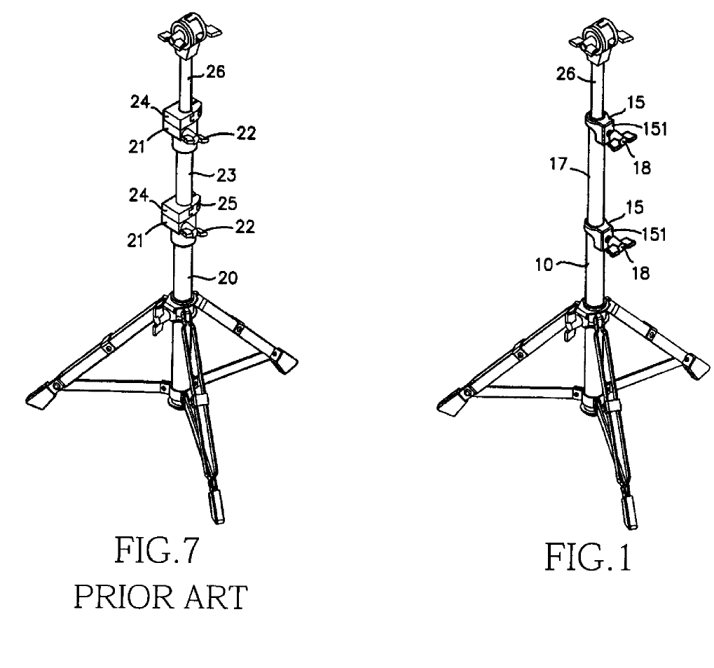

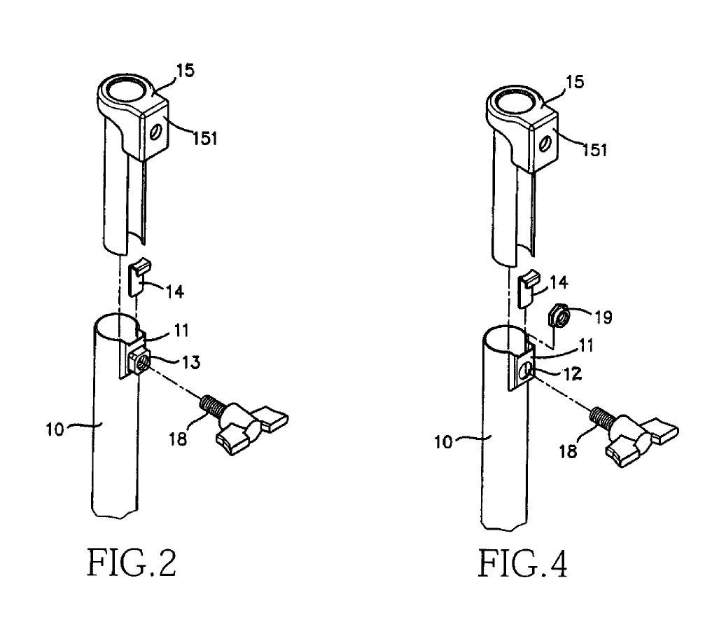

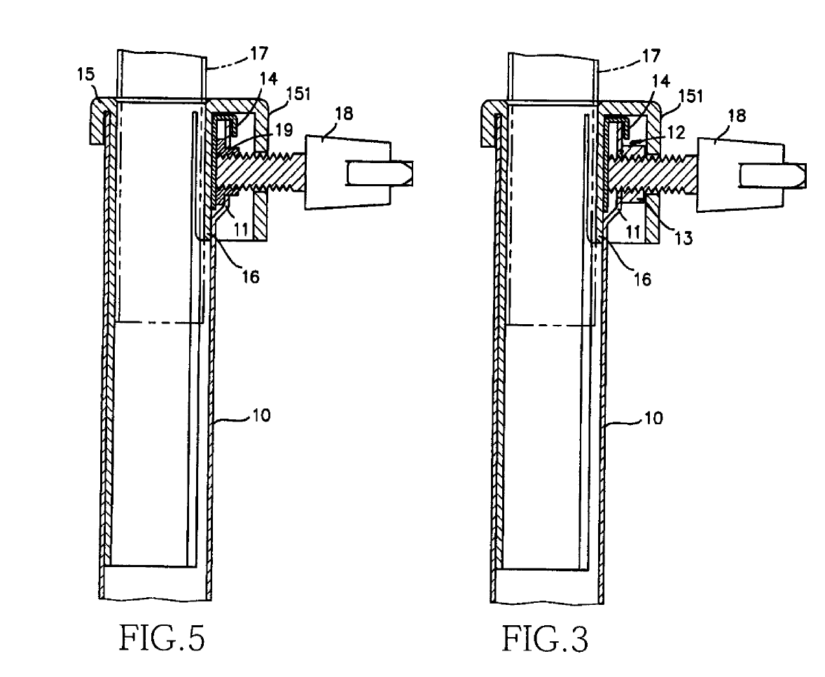

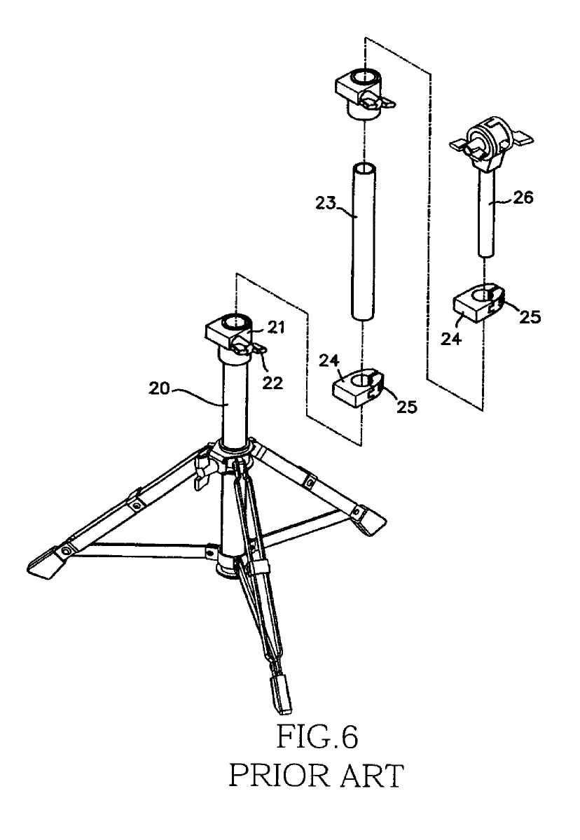

As shown in FIGS. 1 to 3, a telescopic support device according to an embodiment of the present invention contains a number of tubular segments 10. When a tubular segment 10 is made, an outward bulge 11 is directly formed along a top aperture of the tubular segment 10 by impacting. The bulge 11 has a flat surface with a through opening 12. A nut 13 is positioned in front of the through opening 12. A flat and rigid spacer 14 (preferably made of a metallic material) having an inversed-J shaped cross section is hung on a top edge of the bulge 11 and extended into the bulge 11 behind the through opening 12.

The telescopic support device further contains a number of intermediate segments 15, each having a cylindrical body with a C-shaped cross section and a socket besides a top aperture of the body. Please note that an arced plastic piece 16 conforming to the curvature of cylindrical body is positioned between the socket and the body of the intermediate segment 15. When each intermediate segment 15 has its body threaded into a tubular segment 10, the spacer 14, the bulge 11, and the nut 13 of the tubular segment 10 are housed inside the socket where they are behind a flat surface 151 of the socket and in front of the plastic piece 16. Please note that the flat surface 151 also has a through opening, which are aligned with a through opening of the nut 13 and the through opening 12.

As such, when another tubular segment 17 is threaded into the intermediate segment 15, a bolt 18 could be screwed through the flat surface 151, the nut 13, the bulge 11, and then against the spacer 14. The spacer 14 in turn pushes the plastic piece 16 so as to lock the tubular segment 17.

Please note that the entire intermediate segment 15 could be made of a plastic material by molding, which is quite inexpensive. The formation of the bulge 11 is also easy and requires only a low level of expertise. The use of the plastic piece 16 also prevents scratches to the surface of the tubular segment 17.

FIGS. 4 and 5 show another embodiment of the present invention. Unlike the previous embodiment where the nut 13 is positioned outside the bulge 11, the present embodiment has a nut 19 positioned between the bulge 11 and the spacer 14. The nut 19 has a polygonal base and a tube on the base, thereby forming an inversed-T cross section. The base of the nut 19 therefore could be fitted in the bulge 11 with its tube sticking out of the through opening 12. Then, a bolt 18 could be screwed through the flat surface 151, the bulge 11, the nut 19, and then against the spacer 14. The spacer 14 in turn pushes the plastic piece 16 so as to lock the tubular segment 17.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A telescopic support device, comprising:
at least a tubular segment having an outward bulge formed along a top aperture of said tubular segment, said bulge having a flat surface with a through opening, a rigid spacer having an inversed-J shaped cross section hung on a top edge of said bulge and extended into said bulge behind a through opening of said bulge, a nut being positioned either in front of or behind said through opening of said bulge;
at least an intermediate segment having a cylindrical body with a C-shaped cross section and a socket with a flat surface besides a top aperture of said body, a plastic piece being positioned between said socket and body of said intermediate segment;
wherein, when said intermediate segment has said body threaded into said tubular segment, said spacer, bulge, and nut are housed inside said socket behind a through opening of said flat surface of the socket and in front of said plastic piece, a bolt is driven through said through opening of said flat surface of said socket, said nut, said through opening of said bulge, and then against said spacer 14 where said spacer in turn pushes said plastic piece inward.

2. The telescopic support device according to claim 1, wherein said plastic piece is arced in accordance with a curvature of said body of said intermediate segment.

3. The telescopic support device according to claim 1, wherein said spacer is made of a metallic material.

4. The telescopic support device according to claim 1, wherein, when said nut is positioned behind said through opening of said bulge, said nut has a tube sticking out of said through opening of said bulge.

5. The telescopic support device according to claim 4, wherein said nut further has a polygonal base behind said tube for fitting in said bulge.
